(19) United States
(12) Patent Application Publication
(10) Pub. No.: US 2020/0042077 A1
(43) Pub. Date: Feb. 6, 2020

(54) INFORMATION PROCESSING APPARATUS

(71) Applicant: Sony Interactive Entertainment Inc., Tokyo (JP)

(72) Inventors: Jun Hiroi, Tokyo (JP); Osamu Ota, Tokyo (JP)

(73) Assignee: Sony Interactive Entertainment Inc., Tokyo (JP)

(21) Appl. No.: 16/482,576

(22) PCT Filed: Mar. 23, 2017
(86) PCT No.: PCT/JP2017/011777

§ 371 Date: Jul. 31, 2019

(51) Int. Cl. G06F 3/01; G06T 19/00; G02B 27/01; A63F 13/5258

(52) U.S. Cl. CPC G06F 3/011; A63F 13/5258; G02B 27/017; G06T 19/006

(57) ABSTRACT

An information processing apparatus acquires, for each of a plurality of unit portions included in a person, volume element data indicating a position in a virtual space where a unit volume element corresponding to the unit portion is to be arranged, acquires body part data indicating a position of a body part included in the person, arranges, on the basis of the volume element data, a plurality of the unit volume elements in the virtual space, and changes contents of the unit volume elements arranged on the basis of the body part data.

### TECHNICAL FIELD

The present invention relates to an information processing apparatus, an information processing method, and a program for building a virtual space on the basis of information acquired from a real space.

### BACKGROUND ART

Recent years have seen research efforts made in technologies such as augmented reality and virtual reality. One of such technologies builds a virtual space on the basis of information acquired from a real space such as images shot with a camera and allows a user to have an experience as if he or she were in the virtual space. According to such a technology, it is possible for the user to have experiences, which would otherwise not be possible in the real world, in the virtual space related to the real world.

In the above technology, unit volume elements called voxels or point clouds are stacked one on top of the other in the virtual space to represent an object existing in the real space in some cases. By using the unit volume elements, it is possible to reproduce, in the virtual space, various objects existing in a real world without preparing, in advance, information such as colors and shapes of objects existing in the real world.

### SUMMARY

### Technical Problem

In the case where a person such as a user is reproduced in the virtual space by the above technology, it may be desired to reproduce that person in a modified manner in the virtual space rather than reproducing the person in an ‘as-is’ manner. However, in the case where a person is represented by a set of individual unit volume elements, it is difficult to achieve such a modification properly.

The present invention has been devised in light of the above circumstances, and it is an object of the present invention to provide an information processing apparatus, an information processing method, and a program that, in the case where a person is reproduced by a set of unit volume elements in a virtual space, allows the person to be readily reproduced in a modified manner.

### Solution to Problem

An information processing apparatus according to the present invention includes: a volume element data acquisition section adapted to acquire, for each of a plurality of unit portions included in a person, volume element data indicating a position in a virtual space where a unit volume element corresponding to the unit portion is to be arranged; a body part data acquisition section adapted to acquire body part data indicating a position of a body part included in the person; and a volume element arrangement section adapted to arrange, on a basis of the volume element data, a plurality of the unit volume elements in the virtual space. The volume element arrangement section changes contents of the unit volume elements arranged on a basis of the body part data.

An information processing method according to the present invention includes: a step of acquiring, for each of a plurality of unit portions included in a person, volume element data indicating a position in a virtual space where a unit volume element corresponding to the unit portion is to be arranged; a step of acquiring body part data indicating a position of a body part included in the person; and an arrangement step of arranging, on a basis of the volume element data, a plurality of the unit volume elements in the virtual space. The arrangement step changes contents of the unit volume elements arranged on a basis of the body part data.

A program according to the present invention causes a computer to function as: a volume element data acquisition section adapted to acquire, for each of a plurality of unit portions included in a person, volume element data indicating a position in a virtual space where a unit volume element corresponding to the unit portion is to be arranged; a body part data acquisition section adapted to acquire body part data indicating a position of a body part included in the person; and a volume element arrangement section adapted to arrange, on a basis of the volume element data, a plurality of the unit volume elements in the virtual space. The volume element arrangement section changes contents of the unit volume elements arranged on a basis of the body part data. This program may be provided stored in a computer-readable and non-temporal information storage medium.

### BRIEF DESCRIPTION OF DRAWINGS

FIG. 1 is a general overview diagram of an information processing system including an information processing apparatus according to an embodiment of the present invention.

FIG. 2 is a diagram illustrating a manner in which a user uses the information processing system.

FIG. 3 is a diagram illustrating an example of how a virtual space looks.

FIG. 4 is a functional block diagram illustrating functions of the information processing apparatus according to the embodiment of the present invention.

FIG. 5 is a diagram illustrating an example of how the virtual space with changed user objects looks.

### DESCRIPTION OF EMBODIMENT

A detailed description will be given below of an embodiment of the present invention with reference to drawings.

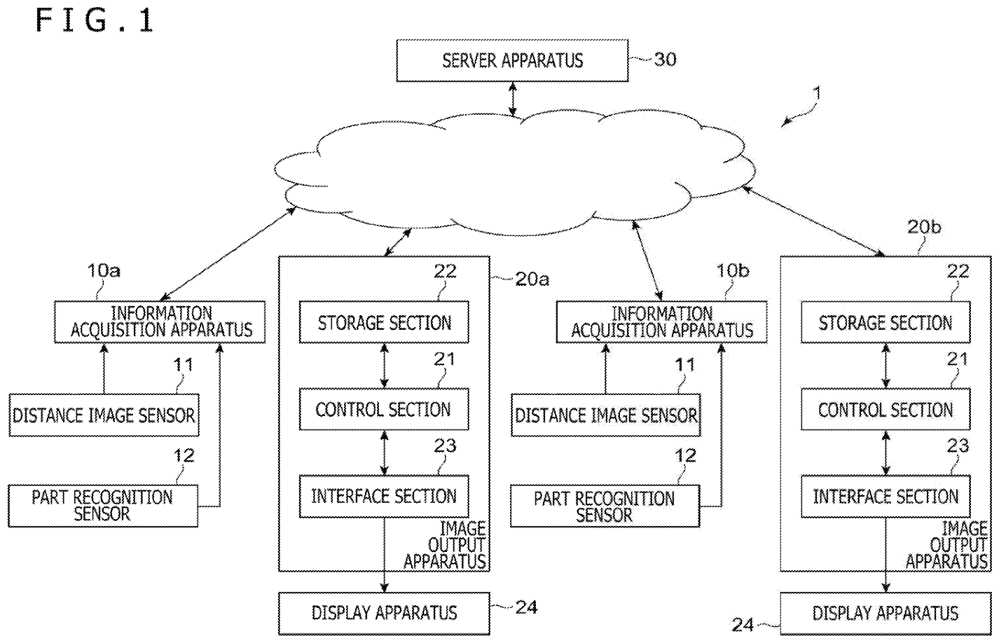

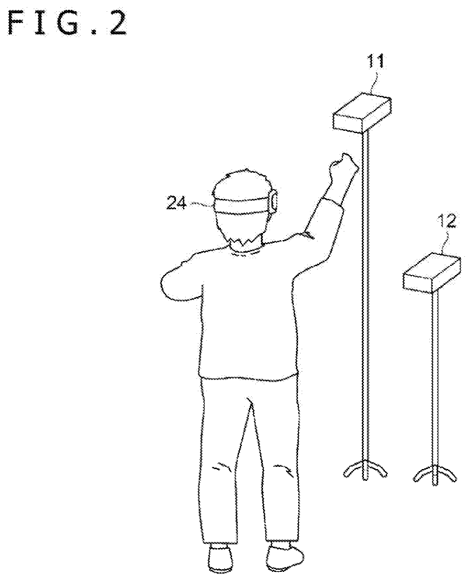

FIG. 1 is a general overview diagram of an information processing system 1 including an information processing apparatus according to an embodiment of the present invention. Also, FIG. 2 is a diagram illustrating an example of a manner in which a user uses the information processing system 1. The information processing system 1 is used to build a virtual space in which a plurality of users participate. According to the present information processing system 1, the plurality of users can play games together in the virtual space and communicate with each other.

The information processing system 1 includes a plurality of information acquisition apparatuses 10, a plurality of image output apparatuses 20, and a server apparatus 30 as illustrated in FIG. 1. Of these apparatuses, the image output apparatuses 20 function as information processing apparatuses according to an embodiment of the present invention. In the description given below, we assume, as a specific example, that the information processing system 1 includes the two information acquisition apparatuses 10 and the two image output apparatuses 20. More specifically, the information processing system 1 includes an information acquisition apparatus 10a and an image output apparatus 20a used by a first user. Also, the information processing system 1 includes an information acquisition apparatus 10b and an image output apparatus 20b used by a second user.

Each of the information acquisition apparatuses 10 is an information processing apparatus such as a personal computer or a home gaming console and connected to a distance image sensor 11 and a part recognition sensor 12.

The distance image sensor 11 acquires information required to generate a distance image (depth map) by observing how a real space including the users of the information acquisition apparatuses 10 looks. For example, the distance image sensor 11 may be a stereo camera that includes a plurality of cameras arranged horizontally side by side. The information acquisition apparatus 10 acquires images shot with the plurality of cameras, thus generating a distance image on the basis of the shot images. Specifically, the information acquisition apparatus 10 can calculate the distance from a shooting position (observation point) of the distance image sensor 11 to a subject appearing in the shot images by taking advantage of parallax of the plurality of cameras. It should be noted that the distance image sensor 11 is not limited to a stereo camera and may be a sensor capable of measuring the distance to the subject by TOF or another scheme, for example.

A distance image is an image that includes, in each unit region included in a field of view, information indicating the distance to the subject appearing in the unit region. As illustrated in FIG. 2, the distance image sensor 11 is installed in such a manner as to point to a person (user) in the present embodiment. Therefore, the information acquisition apparatus 10 can calculate, in a real space, position coordinates of each of a plurality of unit portions of a user's body appearing in the distance image by using a detection result of the distance image sensor 11.

Here, a unit portion refers to a portion of the user's body included in an individual spatial region acquired by partitioning the real space into lattices of a predetermined size. The information acquisition apparatus 10 identifies the position of a unit portion included in the user's body in the real space on the basis of distance information to the subject included in the distance image. Also, the information acquisition apparatus 10 identifies a color of the unit portion from a pixel value of the shot image corresponding to the distance image. This allows the information acquisition apparatus 10 to acquire data representing the positions and colors of the unit portions included in the user's body. Data identifying the unit portions included in the user's body will be hereinafter referred to as unit portion data. As will be described later, it is possible to reproduce the user in the virtual space with the same posture and appearance as in the real space by arranging a unit volume element corresponding to each of the plurality of unit portions in the virtual space. It should be noted that the smaller the size of the unit portions, the higher the resolution at the time of reproduction of the user in the virtual space, thus providing closer-to-real reproduction.

The part recognition sensor 12 acquires information required to identify the position of the user's body part by observing the user as does the distance image sensor 11. Specifically, the part recognition sensor 12 may be a camera or the like used for known bone tracking technique. Also, the part recognition sensor 12 may include a member mounted on the user's body, a sensor for tracking the position of a display apparatus 24 which will be described later, or another device.

The information acquisition apparatus 10 acquires data regarding the position of each part included in the user's body by analyzing the detection results of the part recognition sensor 12. Data regarding the positions of the parts included in the user's body will be hereinafter referred to as body part data. For example, body part data may be data that identifies the position and orientation of each bone at the time of representation of the user's posture with a bone model. Also, body part data may be data that identifies the position and orientation of only a portion of the user's body such as user's head or hand.

The information acquisition apparatus 10 calculates, every given time period and on the basis of the detection results of the distance image sensor 11 and the part recognition sensor 12, unit portion data and body part data and sends these pieces of data to the server apparatus 30. It should be noted that coordinate systems used in these pieces of data to identify the positions of unit portions and body parts must match. For this reason, we assume that the information acquisition apparatus 10 acquires, in advance, information representing the positions of respective observation points of the distance image sensor 11 and the part recognition sensor 12 in the real space. By converting coordinates using position information of the observation points, the information acquisition apparatus 10 can calculate unit portion data and body part data that represent the position of each unit portion and each body part of the user by using a matching coordinate system.

It should be noted that we assume, in the description given above, that the single distance image sensor 11 and the single part recognition sensor 12 are connected to the single information acquisition apparatus 10. However, the present invention is not limited thereto, and the plurality of single distance image sensors 11 and the plurality of single part recognition sensors 12 may be connected to the information acquisition apparatus 10. For example, if two or more distance image sensor 11 are arranged in such a manner as to surround the user, the information acquisition apparatus 10 can acquire, by integrating information acquired from these sensors, unit portion data over a wider area of the user's body surface. Also, more accurate body part data can be acquired by combining the detection results of the plurality of part recognition sensors 12. Also, the distance image sensor 11 and the part recognition sensor 12 may be realized by a single device. In this case, the information acquisition apparatus 10 generates each piece of unit portion data and body part data by analyzing the detection result of this single device.

Each of the image output apparatuses 20 is an information processing apparatus such as a personal computer or a home gaming console and includes a control section 21, a storage section 22, and an interface section 23 as illustrated in FIG. 1. Also, the image output apparatus 20 is connected to the display apparatus 24.

The control section 21 includes at least a processor and performs a variety of information processing tasks by executing a program stored in the storage section 22. A specific example of a process performed by the control section 21 in the present embodiment will be described later. The storage section 22 includes at least a memory device such as a random access memory (RAM) and stores the program executed by the control section 21 and data processed by the program. The interface section 23 is an interface for the image output apparatus 20 to supply a video signal to the display apparatus 24.

The display apparatus 24 displays video to match with a video signal supplied from the image output apparatus 20. We assume, in the present embodiment, that the display apparatus 24 is a head mounted display apparatus worn on the head by the user for use such as head mounted display. We assume that the display apparatus 24 displays, in front of left and right eyes of the user, left and right eye images different from each other. This allows the display apparatus 24 to display a stereoscopic image by taking advantage of parallax.

The server apparatus 30 arranges, on the basis of data received from each of the plurality of information acquisition apparatuses 10, unit volume elements representing the user, other objects, and so on in a virtual space. Also, behaviors of objects arranged in the virtual space are calculated through arithmetic processing such as physics calculations. Then, information regarding positions and shapes of the objects arranged in the virtual space acquired as a result thereof is sent to the plurality of image output apparatuses 20.

More specifically, the server apparatus 30 determines, on the basis of unit portion data received from the information acquisition apparatus 10a, an arrangement position of a unit volume element corresponding to each of a plurality of unit portions included in the unit portion data in the virtual space. Here, unit volume elements are a type of objects arranged in the virtual space and have the same size. Unit volume elements may be of a predetermined shape such as cube. Also, a color of each unit volume element is determined to match with the color of the unit portion. In the description given below, this unit volume element will be denoted as a voxel.

The arrangement position of each voxel is determined to match with the position of the corresponding unit portion in the real space and a reference position of the user. Here, the user's reference position is a position used as a reference for arranging the user and may be a predetermined position in the virtual space. By the voxels arranged as described above, the posture and appearance of the first user existing in the real space are reproduced in the virtual space in an ‘as-is’ manner. In the description given below, data that identifies a group of voxels for reproducing the first user in the virtual space will be referred to as first voxel data. This first voxel data is data that represents the position and color of each voxel in the virtual space. Also, in the description given below, an object representing the first user that includes a set of voxels included in the first voxel data will be denoted as a first user object U1.

It should be noted that the server apparatus 30 may refer to body part data when determining the arrangement position of each voxel in the virtual space. It is possible to identify the position of a user's toe that is assumed to be in contact with a floor by referring to bone model data included in the body part data. By aligning this position with the user's reference position, it is possible to ensure that a height of the voxel arrangement position from a floor in the virtual space coincides with the height of the corresponding unit portion from the floor in the real space. It should be noted that we assume here that the user's reference position is set on a ground in the virtual space.

As with the processes performed on the first user, the server apparatus 30 determines, on the basis of unit portion data received from the information acquisition apparatus 10b, the arrangement position of the voxel corresponding to each of the plurality of unit portions included in the unit portion data in the virtual space. By the voxels arranged as described above, the posture and appearance of the second user is reproduced in the virtual space. In the description given below, data that identifies a group of voxels for reproducing the second user in the virtual space will be referred to as second voxel data. Also, in the description given below, an object representing the second user that includes a set of voxels included in the second voxel data will be denoted as a second user object U2.

Also, the server apparatus 30 arranges an object to be manipulated by the users in the virtual space and calculates its behavior. As a specific example, we assume that two users play a game in which they hit a ball. The server apparatus 30 determines the reference position of each user in the virtual space such that the two users face each other and determines the arrangement position of the voxel group included in each user's body as described above on the basis of this reference position. Also, the server apparatus 30 arranges a ball object B to be manipulated by the two users in the virtual space.

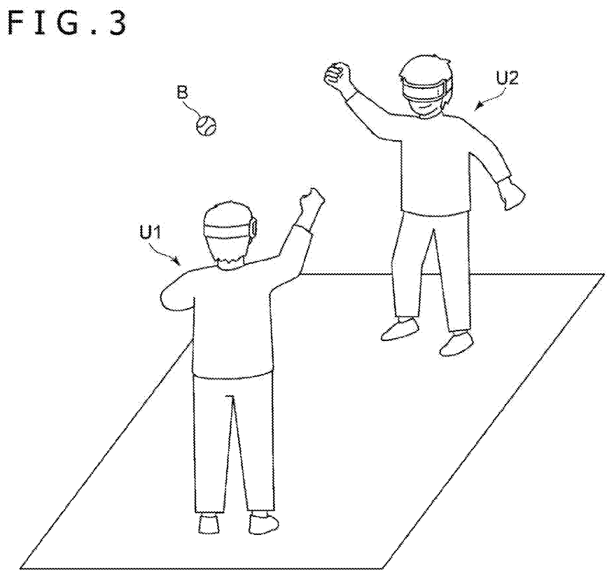

Further, the server apparatus 30 calculates the ball behavior in the virtual space through physics calculations. Also, the server apparatus 30 decides whether contact occurs between each user's body and the ball by using the body part data received from each of the information acquisition apparatuses 10. Specifically, in the case where the position where the user's body exists in the virtual space overlaps the position of the ball object B, the server apparatus 30 decides that the ball has come into contact with the user and calculates the behavior when the ball is reflected by the user. A motion of the ball in the virtual space calculated as described above is displayed on the display apparatus 24 by each of the image output apparatuses 20 as will be described later. Each user can hit back the ball flying toward him or her with the hand by moving his or her body while viewing what is displayed. FIG. 3 illustrates how the ball object B and the user objects, each of which represents each user, arranged in the virtual space in this example, look. It should be noted that, in the example depicted in this figure, a distance image is shot not only from the front side but also from the back side of each user and that the voxels representing the back of each user are arranged in response thereto.

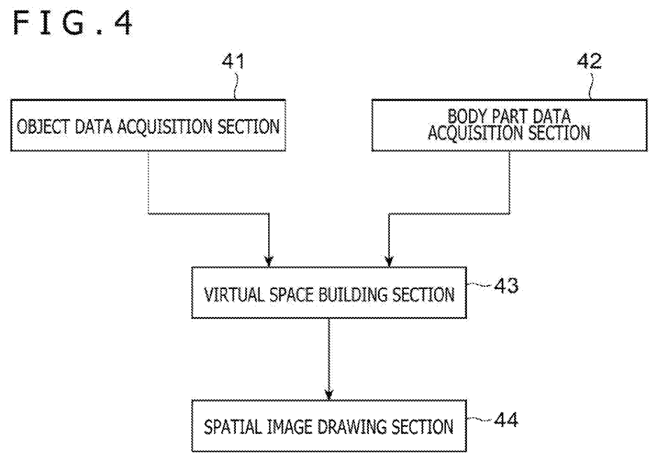

A description will be given below of functions realized by each of the image output apparatuses 20 in the present embodiment on the basis of FIG. 4. As illustrated in FIG. 4, the image output apparatus 20 functionally includes an object data acquisition section 41, a body part data acquisition section 42, a virtual space building section 43, and a spatial image drawing section 44. These functions are realized as a result of execution of the program stored in the storage section 22 by the control section 21. This program may be provided to the image output apparatus 20 via a communication network such as the Internet or may be provided stored in a computer-readable information storage medium such as optical disc. It should be noted that although a description will be given below of the functions realized by the image output apparatus 20a used by the first user as a specific example, we assume that similar functions are realized by the image output apparatus 20b although the target user is different.

The object data acquisition section 41 acquires data representing the position and shape of each object to be arranged in the virtual space by receiving the data from the server apparatus 30. The data acquired by the object data acquisition section 41 includes voxel data of each user and object data of the ball object B. These pieces of object data include information regarding the shape of each object, the position in the virtual space, the surface color, and other information. It should be noted that voxel data need not necessarily include information representing which user each voxel represents. That is, the first voxel data and the second voxel data may be sent from the server apparatus 30 to each of the image output apparatuses 20 as voxel data representing, altogether, the contents of the voxels arranged in the virtual space in a manner not distinguishable one from the other.

Also, the object data acquisition section 41 may acquire, from the server apparatus 30, a background image representing the background of the virtual space. The background image in this case may be, for example, a panoramic image representing a scenery over a wide area through an equirectangular projection format or another format.

The body part data acquisition section 42 acquires body part data of each user sent from the server apparatus 30. Specifically, the body part data acquisition section 42 receives the body part data of the first user and the body part data of the second user respectively from the server apparatus 30.

The virtual space building section 43 builds the contents of the virtual space to be presented to the users. Specifically, the virtual space building section 43 builds the virtual space by arranging each object included in the object data acquired by the object data acquisition section 41 at a specified position in the virtual space.

Here, the voxels included respectively in the first voxel data and the second voxel data are included in the objects arranged by the virtual space building section 43. As described earlier, the positions of these voxels in the virtual space are determined by the server apparatus 30 on the basis of the positions of the corresponding unit portions of the user's body in the real space. For this reason, the actual posture and appearance of each user are reproduced by the set of voxels arranged in the virtual space. Also, the virtual space building section 43 may arrange, around the user object in the virtual space, objects having the background image attached as a texture. This causes the scenery included in the background image to be included in the spatial image which will be described later.

It should be noted, however, that the virtual space building section 43 may change the contents of the voxels to be arranged from those specified by the voxel data rather than arranging the voxels as specified by the voxel data. This modifies part of the user object reproducing the user, providing a space different from the real space. A specific example of such a change process will be described later.

The spatial image drawing section 44 draws a spatial image representing how the virtual space built by the virtual space building section 43 looks. Specifically, the spatial image drawing section 44 sets a view point at the position in the virtual space corresponding to the position of eyes of the user (first user here) to whom the image is to be presented and draws how the virtual space as viewed from that view point looks. The spatial image drawn by the spatial image drawing section 44 is displayed on the display apparatus 24 worn by the first user. This allows the first user to view how the virtual space where the first user object U1 representing the body of himself or herself, the second user object U2 representing the body of the second user, and the ball object B are arranged looks.

The processes performed by each of the information acquisition apparatuses 10, the image output apparatuses 20, and the server apparatus 30 described above are repeated every given time period. The given time period in this case may be, for example, time corresponding to a frame rate of video displayed on the display apparatus 24. This allows each user to view how the user objects that are updated by reflecting, in real time, his or her own motion and the motion of the opponent user in the virtual space look.

A description will be given below of several specific examples of a process for changing the manner in which the voxels are arranged. In these specific examples, the virtual space building section 43 identifies, by using body part data, a region occupied by a given part of the user in the virtual space. Then, the voxel to be arranged in that region is treated as a target to be changed.

A description will be given first of an example in which the voxel representing the user's head is excluded from target voxels to be arranged as a first example. In the real space, the user supposedly cannot directly see his or her own head. However, if the voxel corresponding to the user's head detected by the distance image sensor 11 is arranged in the virtual space, there is a case in which the user's head appears in a spatial image. In particular, in the present embodiment, the user is wearing the display apparatus 24. If left in this way, the voxel representing the display apparatus 24 is arranged together in the virtual space. If, in this condition, the view point is set at the position corresponding to the position of the user's eyes, when the user views the virtual space from that view point, the voxel corresponding to the display apparatus 24 always appears in front of the eyes, thus making other objects and so on invisible behind that voxel. For this reason, the virtual space building section 43 excludes the voxel representing his or her own head of the user viewing the spatial image from the target voxels to be arranged as will be described below.

In this example, the virtual space building section 43 of the image output apparatus 20a used by the first user identifies the position and size of the region occupied by the first user's head (head region) on the basis of the body part data of the first user. This region may be in a predetermined shape such as sphere, cylinder, or rectangular parallelepiped. It is possible to identify the position of a specific body part of the user (e.g., head) and the position of a part adjacent to the specific part (e.g., neck) by referring to the body part data. These pieces of information permit identification of the position and size of the region occupied by a user's specific part.

Further, when arranging, in the virtual space, each of the voxels included in the voxel data, the virtual space building section 43 excludes a voxel whose arrangement position is included in the head region from target voxels to be arranged. Such control ensures that the voxel representing the first user's head is invisible in the spatial image viewed by the first user. As for the regions other than the head region of the first user, the voxels are arranged on the basis of the voxel data. For this reason, the first user can visually recognize the voxels representing his or her body parts such as hands and feet as if they existed at the same positions as his or her body in the real space. Similarly, the voxels representing the second user's body parts including the head are also arranged in the virtual space in an ‘as-is’ manner without being excluded from target voxels to be arranged. For this reason, the first user can visually recognize the whole body of the second user in the virtual space. Here, even in the case where the virtual space building section 43 cannot identify in which user each of the voxels included in the voxel data is included as described earlier, it is only necessary to simply decide whether or not to exclude the voxel from target voxels to be arranged to match with whether or not the arrangement position of the voxel is included in the first user's head region. This allows only the voxel included in the first user's head to be excluded from target voxels to be arranged.

On the other hand, the virtual space building section 43 of the image output apparatus 20b used by the second user excludes the inside of the head region identified on the basis of the body part data of the second user from target voxels to be arranged, contrary to the description given so far. This ensures that the second user's own head is invisible and the first user's head is visible in the spatial image viewed by the second user.

A description will be given next of an example in which a user's specific part is replaced with another object as a second example. In the first example described earlier, the second user's head is represented by the voxel arranged in accordance with the voxel data in the spatial image viewed by the first user. However, the second user's head in this case is generated on the basis of the detection result of the distance image sensor 11 with the display apparatus 24 worn, thus making it impossible for the first user to view a second user's face. For this reason, the virtual space building section 43 may restrict the arrangement of a voxel in the head region occupied by the second user's head as in the first example described earlier and may, instead, arrange a three-dimensional model, prepared in advance, at that position. In this case, the size and orientation of the three-dimensional model may be determined to match with the size and orientation of the part to be replaced (the head here) identified by the body part data. This makes it possible to arrange, in the virtual space and in place of the voxel included in the head of the second user object U2, for example, an avatar representing the second user created in advance or the second user's head model created by using data acquired by shooting a user's photo in person and cause the first user to view the avatar, the head model, and so on.

The virtual space building section 43 may replace not only the head but also another body part of the user with another object. Also in this case, it is possible, by identifying the position, size, and orientation of a target part to be replaced using the body part data, to perform control such that the voxel representing the target part to be replaced is not arranged in the virtual space and to arrange, instead, a three-dimensional model prepared in advance.

As a specific example, the virtual space building section 43 may replace a lower half of the user's body with a three-dimensional model in a vehicle-riding state, in a robot form, or in other forms. In the present embodiment, the user's posture is detected by the distance image sensor 11 and the part recognition sensor 12, thus making it difficult for the user to walk around over a wide area by moving his or her own feet. Therefore, in the case where it is desired to move the user object in the virtual space, it is necessary to issue an instruction regarding how the object is to be moved by a method other than actual movement such as gesture or making operation input with an operating device. In such a case, the replacement of the voxels representing the lower half of the user's body with a different model by the virtual space building section 43 allows for movement of the user object in the virtual space even with the user's feet kept still in a manner unlikely for the user to feel a sense of discomfort.

Also, the virtual space building section 43 may replace the user's hand with a different three-dimensional model. For example, in the case where the user holds an operating device with his or her hand, there is a case in which the reproduction of the operating device in the virtual space in an ‘as-is’ manner is desirably avoided. In such a case, the voxel representing the user's hand is not arranged in the virtual space, and instead, a three-dimensional hand model prepared in advance is arranged. This ensures that what is actually held by the user in his or her hand is not reproduced in the virtual space. Also, the virtual space building section 43 may arrange not only a three-dimensional model representing the user's hand but also, for example, a three-dimensional model representing a different object that does not actually exist such as racket or weapon together in the virtual space.

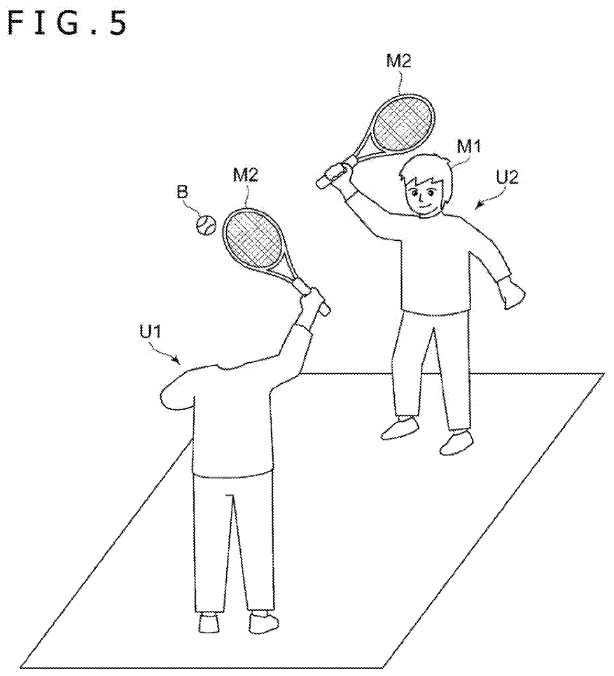

FIG. 5 illustrates an example of how the virtual space with modified user objects looks as a result of the change process as described above. In the example illustrated in this figure, the voxels included in the respective heads and right hands of the first and second users are not arranged in the virtual space. Instead, the virtual space building section 43 arranges a three-dimensional model M1, prepared in advance, at the position where the second user's head is assumed to exist. This three-dimensional model M1 is a model representing the second user's face. Also, the virtual space building section 43 arranges a three-dimensional model M2, prepared in advance, at the positions where the respective right hands of the first and second users are assumed to exist. This three-dimensional model M2 has a shape representing how each user holding a racket with his or her right hand looks. This makes it possible for the first user to view a spatial image that looks as if each of the first user and his or her opponent user were holding a racket.

As described above, the image output apparatus 20 according to the present embodiment allows partial alteration of a voxel for which the position identified on the basis of body part data is specified as an arrangement position while reproducing the appearance and posture of a user actually existing in a real space by restricting the arrangement of the voxel or replacing the voxel with another object.

It should be noted that embodiments of the present invention are not limited to that described above. For example, although two users were reproduced by voxels in a virtual space as a specific example in the description given above, one user or three or more users may be reproduced. Also, in the case where voxels representing a plurality of users are arranged at the same time in a virtual space, each user may be present at a physically remote position as long as the information acquisition apparatus 10 and the image output apparatus 20 used by each user are connected to the server apparatus 30 via a network.

Also, users other than those to be reproduced in a virtual space may view how the virtual space looks. In this case, the server apparatus 30 draws a spatial image indicating how the inside of the virtual space looks as seen from a given view point aside from data to be sent to each of the image output apparatuses 20 and delivers the spatial image as streaming video. By viewing this video, other users not reproduced in the virtual space may view how the inside of the virtual space looks.

Also, not only user objects that reproduce users and objects to be manipulated by the user objects but also an object included in a background and various other objects may be arranged in the virtual space. Also, a shot image acquired by shooting how the real space looks may be attached to an object (e.g., screen) in the virtual space. This allows each user who is viewing how the inside of the virtual space looks with the display apparatus 24 to view how a real world looks at the same time.

Also, at least some of the processes to be performed by the image output apparatuses 20 the description given above may be realized by the server apparatus 30 or another apparatus. As a specific example, the server apparatus 30 may build a virtual space on the basis of each user's body part data and unit portion data and generate a spatial image drawn to depict how the inside thereof looks. In this case, the server apparatus 30 individually controls the arrangement of voxels for each user to whom a spatial image is to be delivered and individually draws the spatial image. That is, the server apparatus 30 builds, for the first user, a virtual space in which no voxel is arranged in the head region of the first user and draws a spatial image representing how the inside thereof looks. Also, when generating a spatial image for the second user, the server apparatus 30 builds a virtual space in which no voxel is arranged in the head region of the second user. Then, the respective spatial images are delivered respectively to the corresponding image output apparatuses 20.

Also, although the information acquisition apparatus 10 and the image output apparatus 20 were independent of each other in the description given above, a single information processing apparatus may realize the functions of both of the information acquisition apparatus 10 and the image output apparatus 20.

### REFERENCE SIGNS LIST

1 Information processing system, 10 Information acquisition apparatus, 11 Distance image sensor, 12 Part recognition sensor, 20 Image output apparatus, 21 Display apparatus, 22 Control section, 22 Storage section, 23 Interface section, 30 Server apparatus, 41 Object data acquisition section, 42 Body part data acquisition section, 43 Virtual space building section, 44 Spatial image drawing section.

1. An information processing apparatus comprising:
a volume element data acquisition section adapted to acquire, for each of a plurality of unit portions included in a person, volume element data indicating a position in a virtual space where a unit volume element corresponding to the unit portion is to be arranged;
a body part data acquisition section adapted to acquire body part data indicating a position of a body part included in the person; and
a volume element arrangement section adapted to arrange, on a basis of the volume element data, a plurality of the unit volume elements in the virtual space,
wherein the volume element arrangement section changes contents of the unit volume elements arranged on a basis of the body part data.

2. The information processing apparatus of claim 1, wherein the volume element arrangement section excludes, from the target unit volume elements to be arranged, a unit volume element whose arrangement position is included in a spatial region occupied by a given part of the person that is determined to match with the body part data.

3. The information processing apparatus of claim 2, wherein the volume element arrangement section excludes, from the target unit volume elements to be arranged, a unit volume element whose arrangement position is included in a spatial region occupied by a head of the person.

4. The information processing apparatus of claim 3, wherein
the volume element data acquisition section acquires the volume element data for each of a plurality of unit portions included in a plurality of persons,
the body part data acquisition section acquires the body part data for each of the plurality of persons, and
the volume element arrangement section excludes, from the target unit volume elements to be arranged, a unit volume element whose arrangement position is included in a spatial region occupied by a head of a given person of the plurality of persons.

5. The information processing apparatus of claim 1, wherein the volume element arrangement section excludes, from the target unit volume elements to be arranged, a unit volume element whose arrangement position is included in a spatial region occupied by a given part of the person that is determined to match with the body part data and arranges a predetermined three-dimensional object in the spatial region.

6. An information processing method comprising:
acquiring, for each of a plurality of unit portions included in a person, volume element data indicating a position in a virtual space where a unit volume element corresponding to the unit portion is to be arranged;
acquiring body part data indicating a position of a body part included in the person; and
arranging, on a basis of the volume element data, a plurality of the unit volume elements in the virtual space,
wherein the arranging changes contents of the unit volume elements arranged on a basis of the body part data.

7. A non-transitory, computer readable storage medium containing a computer program, which when executed by a computer, causes the computer to carry out actions, comprising:
acquiring, for each of a plurality of unit portions included in a person, volume element data indicating a position in a virtual space where a unit volume element corresponding to the unit portion is to be arranged;
acquiring body part data indicating a position of a body part included in the person; and
arranging, on a basis of the volume element data, a plurality of the unit volume elements in the virtual space,
wherein the arranging changes contents of the unit volume elements arranged on a basis of the body part data.
